(19) United States
(12) Patent Application Publication
(10) Pub. No.: US 2015/0157991 A1
(43) Pub. Date: Jun. 11, 2015

(54) COMMINGLING DEVICE

(71) Applicant: Caltec Limited, Milton Keynes (GB)

(72) Inventors: Mirza Najam Ali Beg, Milton Keynes (GB); Mir Mahmood Sarshar, Beaconsfield (GB)

(21) Appl. No.: 14/565,977

(22) Filed: Dec. 10, 2014

(30) Foreign Application Priority Data
Dec. 11, 2013 (GB) 1321916.7

(51) Int. Cl. B01F 5/04

(52) U.S. Cl. CPC B01F 5/0413; B01F 2005/0441

(57) ABSTRACT

A commingling device for combining fluid flows includes an outer fluid line for a first fluid having an inlet end and an outlet end, and an inner fluid line for a second fluid having an inlet end and an outlet end. The inner fluid line has an outlet nozzle at said outlet end, the nozzle being mounted substantially axially within the outer fluid line and configured to direct said second fluid towards the outlet end of the outer fluid line. As a result, the first and second fluids flowing through the inner and outer fluid lines are combined and flow together towards the outlet end of the outer fluid line.

### CROSS-REFERENCE TO RELATED APPLICATION

This application claims priority under 35 USC 119 to British application no. GB 1321916.7 filed Dec. 11, 2013, and the disclosure of said British application is hereby incorporated by reference in its entirety.

### FIELD

The present invention relates to a commingling device for combining the flow of two or more fluids.

### BACKGROUND

There are many situations where a flow of fluids from two different sources or pipelines needs to be combined so that the fluids can flow along a single pipeline. The type of fluid in each pipeline can vary and may consist of pure gas, pure liquid, or a mixture of gas and liquid (multiphase fluids). The flow rates and operating pressures of the two fluids may also be significantly different. Also the flow regimes of the fluids (represented by fluctuations in the flow rates of the fluid phases) may be different, a typical flow regime being slug flow or intermittent flow. In some applications good mixing of the fluids is also desired.

A conventional method used in the oil and gas industry and other industries combines the flow of fluids from two streams using a Tee junction 1 (as shown in FIG. 1) that comprises a first inlet line 2, a second inlet line 3 at right angles to the first inlet line 2, and an outlet line 4 that is aligned with the first inlet line 2. A first flow of fluid enters through the first inlet line 2 and a second flow of fluid enters from the second inlet line 3 at 90 degrees to the first inlet line 2. The first and second fluids are combined and exit the Tee junction through the outlet line 4. However, the mixing of fluids is turbulent, leading to a loss of energy and pressure. The Tee junction 1 shown in FIG. 1 can therefore be used as a commingler, but it is not an efficient commingler as described below.

Using a Tee junction as a commingler is very inefficient, especially when the flow rates or the mass flow rates of the fluids are significantly different from one another. In addition, the pressure of the two streams of fluid in the inlet lines 2, 3 could also be different.

A possible result of combining the flow of fluids from two pipelines with different characteristics using a Tee junction as shown in FIG. 1 is that the fluid stream with the higher mass flow rate or velocity, or the higher momentum of flow, will impose a back pressure on the weaker inlet line, as the momentum of the stronger fluid stream will impose a resistance to flow from the weaker stream, which flows at an angle of 90 degrees into the stronger stream. In oil or gas wells or pipelines carrying flows from different sources, this may restrict production from the weaker source.

An efficient commingler eliminates the shortcomings of the Tee junction arrangement and offers a number of benefits which make the commingler a superior and more efficient unit for combining fluid flow from two separate pipelines or sources.

A key feature of an efficient commingler is that it enables the two fluids to commingle whilst flowing along parallel flow paths, instead of being combined at 90 degrees to one another as in a conventional Tee junction arrangement.

A more efficient commingler is disclosed in EP 0717818 B1. This document describes an apparatus for mixing two fluid streams, which includes a nozzle mounted within an outlet conduit, which is arranged to introduce a stream of gas in a streamline manner into another fluid stream by directing the gas axially along the outlet conduit.

### SUMMARY

It is an object of the present invention to provide a commingling device that mitigates one or more of the problems set out above or that provides a useful alternative thereto.

According to one aspect of the present invention there is provided a commingling device for combining fluid flows, comprising an outer fluid line for a first fluid having an inlet end and an outlet end, an inner fluid line for a second fluid having an inlet end and an outlet end, said inner fluid line having an outlet nozzle at said outlet end, said nozzle being mounted substantially axially within the outer fluid line and configured to direct said second fluid towards the outlet end of the outer fluid line, whereby said first and second fluids flowing through the inner and outer fluid lines are combined and flow together towards the outlet end of the outer fluid line.

By combining the fluid flows so that they flow axially and in a streamlined fashion towards the outlet the efficiency of the commingler can be significantly improved, so that it is able to operate with a minimal loss of pressure and a low energy requirement.

In one preferred embodiment, the outer fluid line is non-straight and the inner fluid line is substantially straight and has an outlet end that is located substantially axially within a downstream portion of the outer fluid line. Advantageously, the outer fluid line is curved. This arrangement is particularly suitable for situations where the first fluid supplied to the outer fluid line is at a relatively low pressure or has a low momentum and the second fluid supplied to the inner fluid line is at a relatively high pressure or has a high momentum, being capable of operating with high efficiency in these conditions.

In another preferred embodiment, the inner fluid line is non-straight and the outer fluid line includes a substantially straight pipe section, and the inner fluid line has an outlet end that is located substantially axially within a downstream portion of the substantially straight pipe section. This arrangement is mechanically simpler and may be preferred in certain situations.

Advantageously, the commingling device includes a Tee-piece pipe section comprising a substantially straight pipe section and a branch pipe section that intersects the substantially straight pipe section. The inner fluid line preferably includes an inlet end mounted within the branch pipe section and an outlet end located within the substantially straight pipe section. Advantageously, the inner fluid line is curved. This configuration is simple to implement and can be assembled using mostly conventional and readily available components.

Advantageously, the inner fluid line includes an upstream portion that extends substantially perpendicular to a longitudinal axis of the substantially straight pipe section, and a downstream portion that extends substantially parallel to the longitudinal axis of the substantially straight pipe section. This configuration may be preferred where a curved inner fluid line cannot be accommodated.

In another preferred embodiment the commingling device includes a Tee-piece pipe section comprising a substantially straight pipe section and a branch pipe section that intersects the substantially straight pipe section, and a removable inlet transfer pipe mounted within the Tee-piece pipe section and connected to the inlet end of either the substantially straight pipe section or the branch pipe section for guiding the flow of either the first fluid or the second fluid. In this configuration a highly efficient commingler can be assembled using largely conventional components, often without making extensive changes to existing pipework.

In one embodiment, the inlet transfer pipe is connected to the inlet end of the branch pipe section and comprises an upstream portion that extends substantially perpendicular to a longitudinal axis of the substantially straight pipe section, and a downstream portion that extends substantially parallel to the longitudinal axis of the substantially straight pipe section. Again, this configuration may be useful where a curved inner fluid line cannot be accommodated.

Optionally, the inlet transfer pipe may be configured to be withdrawn from the substantially straight pipe section in a direction substantially perpendicular to a longitudinal axis of the substantially straight pipe section. This allows the straight pipe section to be cleaned or inspected using a pipeline inspection gauge (or “pig”).

In another embodiment, the inlet transfer pipe mounted within the Tee-piece pipe section is connected to the inlet end of the substantially straight pipe section and extends towards the outlet end of the substantially straight pipe section. This provides a useful alternative configuration, which is suitable for different fluid flow conditions.

Advantageously, the commingling device includes an outlet transfer pipe mounted within the Tee-piece pipe section, wherein said outlet transfer pipe is connected to the outlet end of the substantially straight pipe section and extends upstream towards the downstream end of the inlet transfer pipe.

Advantageously, the commingling device includes a spinner device mounted within the inner fluid line and configured to cause rotation of said second fluid flowing within the inner fluid line. Alternatively or additionally the commingling device may include a spinner device mounted within the outer fluid line and configured to cause rotation of said first fluid flowing within the outer fluid line. The use of spinner devices ensures that the first and second fluids are mixed thoroughly and efficiently, even when the flow characteristics of the fluids are very different.

According to another aspect of the invention there is provided a commingling device for combining fluid flows, comprising a first fluid line for a first fluid having an inlet end and an outlet end, and a second fluid line for a second fluid having an inlet end and an outlet end, wherein said second fluid line intersects said first fluid line between the inlet and outlet ends thereof, and wherein said second fluid line has a longitudinal axis that extends at an acute angle to a longitudinal axis of the first fluid line, whereby said first and second fluids flowing through the first and second fluid lines are combined and flow together towards the outlet end of the first fluid line. This configuration allows the straight pipe section to be cleaned or inspected using a pipeline inspection gauge (or “pig”).

Advantageously, the longitudinal axis of said second fluid line extends at least partially tangentially with respect to the first fluid line, whereby said second fluids flowing into said first fluid lines are caused to rotate about a longitudinal axis of the first fluid line.

According to another aspect of the invention there is provided a commingling device for combining fluid flows, comprising a first fluid line for a first fluid having an inlet end and an outlet end, and a second fluid line for a second fluid having an inlet end and an outlet end, wherein said outlet end of said second fluid line is connected to said first fluid line through an intermediate pipe section having a plurality of apertures through which the second fluid can flow into the first fluid line. This configuration also allows the straight pipe section to be cleaned or inspected using a pipeline inspection gauge (or “pig”).

Advantageously, at least one of said apertures extends at an acute angle to a longitudinal axis of the first fluid line, whereby said first and second fluids flowing through the first and second fluid lines are combined and flow together towards the outlet end of the first fluid line.

Advantageously, at least one of said apertures extends at least partially tangentially with respect to the first fluid line, whereby said second fluids flowing into said first fluid lines are caused to rotate about a longitudinal axis of the first fluid line.

Advantageously, said first fluid line is piggable and has no substantial obstructions between the inlet and outlet ends thereof.

### BRIEF DESCRIPTION OF DRAWINGS

Various embodiments of the present invention will now be described by way of example with reference to the accompanying drawings, wherein:

FIG. 1 is a side view of a prior art commingling device;

FIG. 2 is a partially sectional side view of a commingling device according to a first embodiment of the invention;

FIG. 3 is a partially sectional side view of a commingling device according to a second embodiment of the invention;

FIG. 4A is a partially sectional side view of a commingling device according to a third embodiment of the invention;

FIG. 4B is a partially sectional side view of a commingling device according to a fourth embodiment of the invention;

FIG. 4C is a partially sectional side view of a commingling device according to a fifth embodiment of the invention;

FIG. 5 is a partially sectional side view of a commingling device according to a sixth embodiment of the invention;

FIG. 5A is a partially sectional side view showing part of a commingling device according to a seventh embodiment of the invention, being a first variant of the sixth embodiment;

FIG. 5B is a partially sectional side view showing part of a commingling device according to an eighth embodiment of the invention, being a second variant of the sixth embodiment;

FIG. 5C is a cross sectional end view of the commingling device shown in FIG. 5B;

FIG. 6 is a partially sectional side view of a commingling device according to a ninth embodiment of the invention;

FIG. 6A is a cross section on line A-A of FIG. 6, and

FIG. 7 is a partially sectional side view of a commingling device according to a tenth embodiment of the invention.

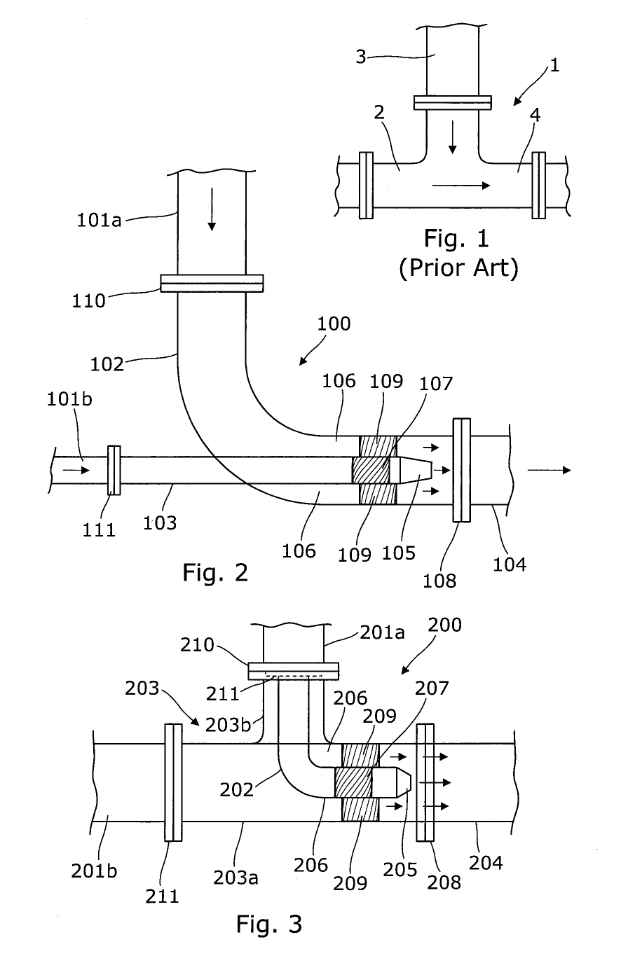

### DETAILED DESCRIPTION

The first commingling device 100 shown in FIG. 2 is connected to first and second inlet lines 101a, 101b and outlet line 104 via radial flanges 108, 110, 111. The commingling device 100 includes a relatively large diameter elbow pipe section 102 that bends through an angle of approximately 90° and a relatively small diameter straight pipe section 103 that passes through and is welded to the wall of the elbow pipe section 102. The straight pipe section 103 extends axially in the direction of the downstream end of the elbow pipe section 102, which is connected to the outlet line 104 via flange 108. A nozzle 105 is provided on the outlet end of the straight pipe section 103.

The small diameter straight pipe section 103 is located axially within the elbow pipe section 102 providing an annular region 106 between the wall of the straight pipe section 103 and wall of the elbow pipe section 102. A first static spinner device 107, for example comprising fan blades or helical fins, is provided within the straight pipe section 103 towards the downstream end thereof This first static spinner device 107 may be located upstream of and/or within the nozzle 105. A second static spinner device 109, comprising for example fan blades or helical fins, may be provided within the annular region 106 between the elbow pipe section 102 and the straight pipe section 103. This second static spinner device 109 may be mounted on the interior surface of the elbow pipe section 102 and/or on the exterior surface of the straight pipe section 103.

In use, first and second fluid streams flow into the commingling device 100 through the first and second inlet lines 101a, 101b. The fluid stream flowing through the second inlet line 101b passes through the straight pipe section 103 and the nozzle 105 and is introduced in a streamlined manner into the first fluid stream that flows from the first inlet line 101a into the elbow pipe section 102. The first and second spinners 107, 109 cause the first and second fluids flows to rotate in the same direction about the longitudinal axis of the straight pipe section 103, which aids mixing of the first and second fluids. The mixed fluids then exit the commingling device through the outlet line 104. Because the fluids are commingled in a streamlined manner there is very little loss of pressure or momentum and the commingling device is therefore very efficient in operation.

The second commingling device 200 shown in FIG. 3 is connected to first and second inlet lines 201a, 201b and to outlet line 204 via radial flanges 208, 210, 211. The commingling device 200 includes a relatively small diameter elbow pipe section 202 that is connected to the first inlet line 201a and bends through an angle of approximately 90°. The commingling device 200 also includes a relatively large diameter Tee joint 203, which comprises a straight pipe section 203a and a branch pipe section 203b that intersects the straight pipe section 203a at an angle of approximately 90°. The elbow pipe section 202 extends from the inlet end of the branch pipe section 203b into the straight pipe section 203a and is configured so that the outlet end of the elbow pipe section 202 extends axially in the direction of the downstream end of the straight pipe section 203a. A flange 211 is provided at the upstream end of the elbow pipe section 202, which sits within a recess at the upstream end of the branch pipe section 203b to support the elbow pipe section 202. The flange 211 prevents fluids flowing from the first inlet line 201a directly into the branch pipe section 203b. Any fluids flowing through the first inlet line 201 a are therefore forced to flow through the elbow pipe section 202. A nozzle 205 is provided at the outlet end of the elbow pipe section 202 to direct the first fluids axially into the straight pipe section 203a.

The downstream end of the small diameter elbow pipe section 202 is located approximately axially within the straight pipe section 203a, providing an annular region 206 between the wall of the straight pipe section 203a and wall of the elbow pipe section 202. A first static spinner device 207, for example comprising fan blades or helical fins, is provided within the downstream end of the elbow pipe section 202. This first static spinner device 207 may be located upstream of or within the nozzle 205. A second static spinner device 209, comprising for example fan blades or helical fins, is provided within the annular region 206 between the elbow pipe section 202 and the straight pipe section 203a. This second static spinner device 209 may be mounted on the interior surface of the straight pipe section 203a and/or on the exterior surface of the elbow pipe section 202.

FIGS. 2 and 3 show a number of important features of the commingler. Both commingling devices 100, 200 serve the same function but for some operating companies the Tee shaped commingler 200 shown in FIG. 3 will be preferred because of the simpler or superior welding details offered by the design. In the case of the elbow type commingler 100 shown in FIG. 2 extra welding is needed where line 103 passes through the elbow 102, which some operators may not prefer.

In the first commingling device 100 shown in FIG. 2, a short or long radius pipe bend or elbow 102 is preferably used as the flow path for the fluids with less momentum, whilst the straight pipe section 103 is used as the flow path for the fluids with a higher momentum. Often one of the fluid streams will have a higher pressure than the other fluid stream. The difference in pressures could vary and may range from a few millibar, for example 2 millibar (200 Pa), to several bar (several times 100 kPa). In this case the fluids with the lower pressure may be called LP fluids, and the fluids with the higher pressure may be called HP fluids.

The LP fluids flow through the elbow 102 and are guided to pass through the annulus 106 between the elbow 102 and the straight pipe section 103 before the two fluids are combined along the same axis in front of the nozzle 105.

The nozzle 105 attached to the downstream end of straight pipe section 103 is designed such that if the pressure of the fluids passing through the pipe section 103 is higher than the pressure of the fluids from line 101a, the nozzle 105 enables the pressure of the fluids from line 103 to drop to the pressure of the inlet line 101a and the outlet line 104 when the two fluids are combined uniaxially, so that they can flow unimpeded through downstream outlet line 104.

In the case of the Tee type commingler 200 shown in FIG. 3, the elbow type pipe section 202 is removably fixed into the Tee section via the flange 211, which is fixed or bolted onto the main flange 210 of the Tee section.

In both cases shown in FIGS. 2 and 3 the commingling device 100, 200 is designed and sized so that the mixture velocities of the two fluids are close to one another when the two fluids are combined downstream of the nozzle 105, 205. The size of each pipe section or elbow is generally selected from the standard pipe sections available in the industry and is selected so that the velocity of fluid within each stream does not exceed the limit generally recommended for that pipe section, so as to avoid excessive erosion of the pipe section. The typical pipe sections vary from ¼ inch to 48 inch (0.6 cm to 122 cm) diameter, but the invention is not limited to these sizes, which depend on the flow rate of each fluid stream.

The use of a small diameter pipe section for one fluid stream is applicable mainly to cases when chemicals such as wax inhibitors or glycol are introduced in small doses into the main stream and good mixing of the flow from the two streams is desired.

One preferred feature of the commingler is the use of a screw type fluid spinning static spinner device 107, 207 as part of the nozzle assembly 105, 205. This spinner device generates spinning and rotation of the fluids passing through the nozzle assembly. Spinning the fluids helps the flow from the two streams to mix thoroughly when they are commingled beyond the nozzle 105, 205. This spinner device is particularly effective when the flow passing through the nozzle is a liquid phase and the fluid passing through the annulus 106, 206 is a gas. If the commingling device does not include a static spinner there may be a tendency for the liquid phase to jet through the gas phase without mixing with the gas.

Alternatively or additionally, a second fluid spinner device 109, 209 may be installed within the annulus 106, 206 between the elbow section and the main pipe section as shown in FIGS. 2 and 3. With this second static fluid spinner device flow from the first fluid stream can be subjected to spinning action. The spinning device is of fixed type and does not rotate, but its screw like fin configuration causes the fluids to spin as they pass through the spinner. When both spinners are used, they are arranged to spin both fluids in the same direction.

The efficient commingler described above is generally supplied with flanges at the inlet and outlet ends, allowing it to be connected securely with existing pipe work without the need for welding work on site.

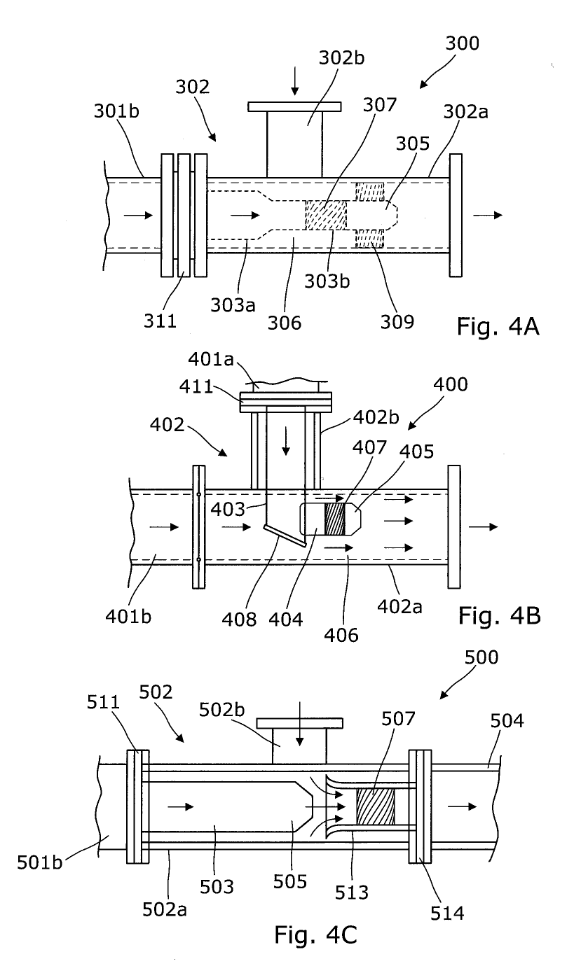

Another type of commingler is the insert type, which can be introduced into an existing Tee joint. Three different commingling devices of the insert type are shown in FIGS. 4A, 4B and 4C.

The commingling device 300 shown in FIG. 4A includes a conventional Tee joint 302, which comprises a straight pipe section 302a and a branch pipe section 302b that intersects the straight pipe section 302a at an angle of approximately 90°.

The commingling device 300 also includes a transfer pipe 303, which is mounted within the straight pipe section 302a and extends axially from the inlet end of the straight pipe section 302a past the branch pipe section 302b and towards the downstream end of the straight pipe section 302a. The transfer pipe 303 includes a large diameter section 303a at its upstream end and a smaller diameter section 303b at its downstream end, which is connected to a nozzle assembly 305. A flange 311 is provided at the upstream end of the transfer pipe section 303, which sits within a recess at the upstream end of the straight pipe section 302a to support the transfer pipe 303. The flange 311 prevents fluids flowing from the second inlet line 301b directly into the straight pipe section 302a. Instead, any fluids flowing through the second inlet line 301b are forced to flow through the transfer pipe 303. A nozzle 305 is provided at the outlet end of the transfer pipe 303 to direct the fluids flowing through the transfer pipe 303 axially into the straight pipe section 302a with a streamlined flow.

The downstream end of the transfer pipe 303 is located axially within the straight pipe section 302a, providing an annular region 306 between the wall of the transfer pipe 303 and wall of the straight pipe section 302a. A first static spinner device 307, for example comprising fan blades or helical fins, is provided within the downstream end of the transfer pipe 303. This first static spinner device 307 may be located upstream of and/or within the nozzle 305. A second static spinner device 309, comprising for example fan blades or helical fins, is provided within the annular region 306 between the transfer pipe 303 and the straight pipe section 302a. This second static spinner device 309 may be mounted on the interior surface of the straight pipe section 302a and/or on the exterior surface of the transfer pipe 303.

In use, a first fluid stream flows into the commingling device 300 through the branch pipe section 302b and a second fluid stream flows into the transfer pipe 302 through the second inlet line 301b. The fluid stream flowing through the second inlet line 301b passes through the transfer pipe 303 and the nozzle 305 and is introduced in a streamlined manner into the first fluid stream that flows from the branch pipe section 302b into the straight pipe section 302a. The first and second spinners 307, 309 cause the first and second fluid flows to rotate in the same direction about the axis of the straight pipe section 302a, which aids mixing of the first and second fluid streams. The mixed fluids then exit the commingling device through an outlet line connected to the downstream end of the straight pipe section 302a. Because the fluids are commingled in a streamlined manner there is very little loss of pressure or momentum and the commingling device is therefore very efficient in operation.

The commingling device 400 shown in FIG. 4B includes a conventional Tee joint 402, which comprises a straight pipe section 402a and a branch pipe section 402b that intersects the straight pipe section 402a at an angle of approximately 90°.

The commingling device 400 includes a transfer pipe 403, which is mounted within the branch pipe section 402b and extends into the straight pipe section 402a. At its downstream end the transfer pipe 403 has a transverse pipe section 404 that extends axially towards the downstream end of the straight pipe section 402a. A nozzle 405 is provided at the outlet end of the transverse pipe section 404 to direct the fluids flowing through the transfer pipe 403 axially into the straight pipe section 402a with a streamlined flow. An inclined plate 408 is provided at the downstream end of the transfer pipe 403 to direct the flow of fluids towards the transverse pipe section 404.

A flange 411 is provided at the upstream end of the transfer pipe 403, which sits within a recess at the upstream end of the branch pipe section 402b to support the transfer pipe 403. The flange 411 prevents fluids from flowing directly into the branch pipe section 402b. Instead, any fluids flowing through the first inlet line are forced to flow through the transfer pipe 403.

The transverse pipe section 404 is located axially within the straight pipe section 402a, providing an annular region 406 between the wall of the transverse pipe section 404 and wall of the straight pipe section 402a. A static spinner device 407, for example comprising fan blades or helical fins, is provided within the downstream end of the transverse pipe section 404. This static spinner device 407 may be located upstream of and/or within the nozzle 405. A second static spinner device (not shown) may optionally be provided within the annular region 406 between the transverse pipe section 404 and the straight pipe section 402a. This second static spinner device, if provided, may be mounted on the interior surface of the straight pipe section 402a and/or on the exterior surface of the transverse pipe section 404.

In use, a first fluid stream flows from a first inlet line 401a into the transfer pipe 403 and a second fluid stream flows into the straight pipe section 402a from the second inlet line 401b. The first fluid stream passes through the transfer pipe 403 and the nozzle 405 and is introduced in a streamlined manner into the second fluid stream that flows through the straight pipe section 402a. The spinner 407 causes the second fluid flow to rotate about axis of the straight pipe section 402a, which aids mixing of the first and second fluid streams. The mixed fluids then exit the commingling device 400 through an outlet line connected to the downstream end of the straight pipe section 402a. Because the fluids are commingled in a streamlined manner there is very little loss of pressure or momentum and the commingling device is therefore very efficient in operation.

The commingling device 500 shown in FIG. 4C includes a conventional Tee joint 502, which comprises a straight pipe section 502a and a branch pipe section 502b that intersects the straight pipe section 502a at an angle of approximately 90°.

The commingling device 500 includes an inlet transfer pipe 503, which is mounted within the straight pipe section 502a and extends axially from the inlet end of the straight branch pipe section past the branch pipe section 502b and towards the downstream end of the straight pipe section 502a. The downstream end of the inlet transfer pipe 503 is connected to a nozzle assembly 505. A flange 511 is provided at the upstream end of the inlet transfer pipe 503, which sits within a recess at the upstream end of the straight pipe section 502a to support the inlet transfer pipe 503. The flange 511 prevents fluids flowing from the second inlet line 501b directly into the straight pipe section 502a. Instead, any fluids flowing through the second inlet line 501b are forced to flow through the inlet transfer pipe 503. The nozzle 505 at the outlet end of the inlet transfer pipe 503 directs the fluids flowing through the inlet transfer pipe 503 axially into the straight pipe section 502a with a streamlined flow.

The commingling device 500 also includes an outlet transfer pipe 513, which is mounted within the straight pipe section 502a and extends axially from a point downstream of the nozzle 505 to the downstream end of the straight pipe section 502a. The downstream end of the outlet transfer pipe 503 includes a flange 514, which sits within a recess at the downstream end of the straight pipe section 502a to support the outlet transfer pipe 513. The flange 511 prevents fluids flowing from the straight pipe section 502a directly into the outlet pipe 504. Instead, only fluids flowing through the outlet transfer pipe 513 are allowed to flow into the outlet pipe 504. The upstream end of the outlet transfer pipe 513 is flared to capture the fluids flowing through the inlet transfer pipe 503 and the branch pipe section 502b.

A static spinner device 507, for example comprising fan blades or helical fins, is provided within the outlet transfer pipe 513. This static spinner device 507 helps to mix the fluids passing through the outlet transfer pipe 513.

In each of the commingling devices shown in FIGS. 4A, 4B and 4C each insert (the inlet and outlet transfer pipes) is designed and sized to match the operating conditions. The inserts are equipped with their own flanges, which can be bolted to the pipe work with conventional nuts and bolts (not shown). The inserts can be introduced from the three ports of the Tee joint 302, 402, 502 as dictated by the fluids in each stream. Additionally, an insert with reduced cross section area can be introduced from the discharge end of the Tee piece (as shown in FIG. 4C), which can also be equipped with a static spinner to enable good mixing of the fluids.

Additionally each of the inserts shown in FIGS. 4A, 4B and 4C can be equipped with static fluid spinners.

In cases where the size of the pipe section does not allow an elbow to be used, a straight pipe section can be used, as shown in FIG. 4B. In this case the end of the pipe insert can be cut at an angle and blinded by welding a plate to guide the fluid flow into the transverse pipe section 404, which is welded to the transfer pipe 403 at 90 degrees to the axis thereof.

### Piggable Commingler

There are cases where at least one of the pipelines has to be piggable: that is, it has to be possible to insert a pipeline inspection gauge (or “pig”) for the purpose of inspecting or cleaning the line whenever needed. In this case if a commingler is used to combine flow from two streams, there should be no intrusive equipment or parts within the pipeline to block the passage of the pig.

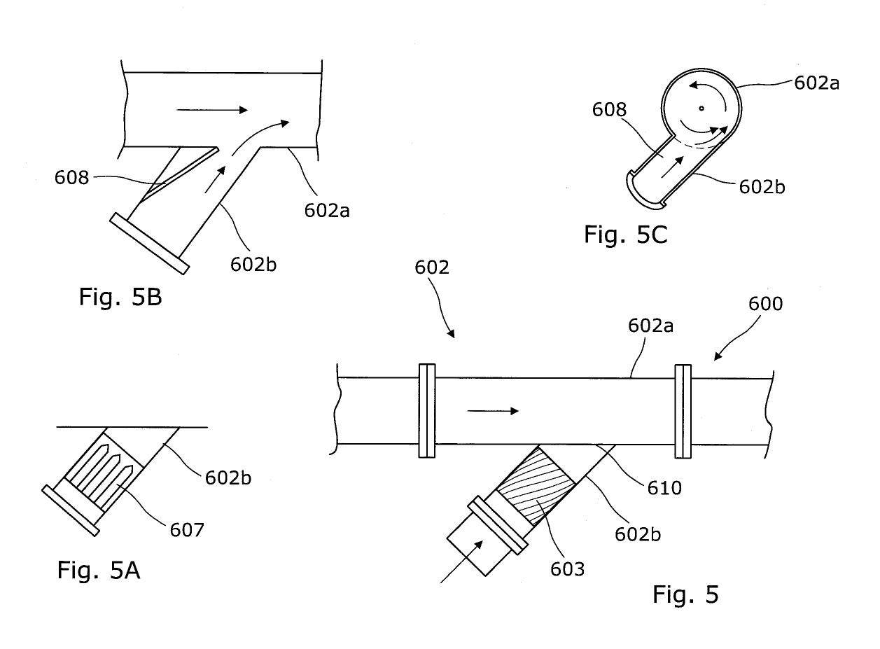

To overcome this problem, the arrangement in FIG. 5, 6 or 7 can be used depending on the flow conditions and the thoroughness of mixing desired.

FIG. 5 shows a commingling device 600 that includes a Y-piece 602, which comprises a straight pipe section 602a and a branch pipe section 602b that intersects the straight pipe section 602a at an acute angle (in this case of approximately) 45°). A spinner device 603 is mounted within the branch pipe section 602b. The straight pipe section 602a has an upstream end connected to a first inlet line 604 and a downstream end connected to an outlet line 605. The branch pipe section 602b has an upstream end that is connected to a second inlet line 606.

A first fluid flows through the first inlet line 604 into the straight pipe section 602a. A second fluid enters through the branch pipe section 602b and is mixed with the first fluid within the straight pipe section 602a. The branch pipe section 602b can be equipped with a static spinner 603 to generate a spinning action of the fluids entering the commingling device 600 and achieve a good mixing of the two fluids. The straight pipe section 602 may also be equipped with guide strips 610 that extend across the entry port of the branch pipe 602b to prevent a pig passing through the straight pipe section 602a from becoming stuck in this area.

In a modified version of the commingling device, the static spinner 603 may be replaced with a bundle of nozzles 607 as shown in FIG. 5A to generate high velocity of fluids entering straight pipe section 602a and achieve good mixing of the two fluids.

In a further modified configuration shown in FIG. 5B the branch pipe section 602b is welded to the straight pipe section 602a with the axis of the branch pipe section offset from the centre line of the straight pipe section 602a, such that the upper part of the branch pipe section 602b is tangential to the upper part of the straight pipe section 602a. This feature enables fluids from the branch pipe section 602b to enter tangentially into the straight pipe section 602a, thus automatically creating a rotating motion of the fluids and enabling good mixing of the flow from the two lines. In this configuration the commingler 600 may also include a plate 608 that is welded at the outlet end of the branch pipe section 602b so that the outlet area of the branch pipe section 602b is further restricted to increase the velocity of fluid flow and increase the spinning action generated by the fluids flowing from the branch pipe section 602b into the straight pipe section 602a.

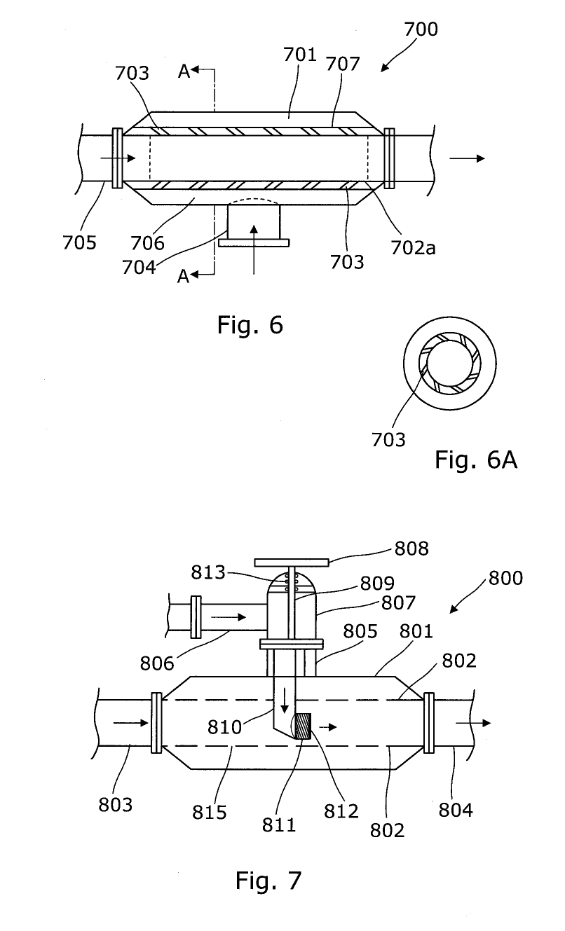

FIGS. 6 and 6A show another type of piggable commingler 700 where a spool piece 701 which has a larger diameter than the main pipeline 705 acts as a Tee section allowing a second fluid to enter via inlet line 704 into an annular space 706 between the wall of the spool piece 701 and the pipeline 705. A pipe section 707 housed within the spool piece 701 has the same internal diameter as the pipe line 705. The pipe section 707 has holes drilled along its length, which act as nozzles 703. These nozzles 703 can also be of angled or radial orientation as shown in section A-A (FIG. 6A) to create some rotational motion of the fluids passing through the nozzles and in this way help to improve mixing of the fluids.

FIG. 7 shows another type of piggable commingler 800, which uses a Tee section similar to that shown in FIG. 4B, which is connected to a first inlet pipe 803, a second inlet pipe 806 and an outlet pipe 804. In this case a transfer pipe 810 and a transverse pipe section 811 are movable in the axial direction of a branch pipe section 805, so that when a pigging operation is required, these pipe sections 810, 811 can be moved back into a housing 807 to clear the path of the pig passing through the straight pipe section 802. The commingler includes a housing 807, an adjusting handle 808, a screw mechanism 813 with one or more seals to seal the moving stem 809 passing through body 807 and a retrieving stem 809, which may have a similar construction to that of a normal gate valve housing, which allows the transfer pipe 810 and the transverse pipe section 811 to be retracted into the housing 807 during a pigging operation. A nozzle 812 is provided at the downstream end of the transverse pipe portion 811.

The commingler 800 includes a spool piece 801 which has a larger diameter than the main pipeline 803 and acts as a Tee section allowing a second fluid to enter via inlet line 806. A pipe section 802 housed within the spool piece 801 has the same internal diameter as the inlet pipe line 803. The pipe section 802 has holes 815 drilled along its length, which act as nozzles. The second fluid in this case can enter via line 806 into the housing 807, and then enters the straight pipe section 802 via the retractable transfer pipe 810 and the transverse pipe section 811.

In all cases one fluid may be denser or more viscous than the other and it is for this reason that good mixing of the fluids is desired.

1. A commingling device for combining fluid flows, comprising an outer fluid line for a first fluid comprising an inlet end and an outlet end, an inner fluid line for a second fluid comprising an inlet end and an outlet end, said inner fluid line comprising an outlet nozzle at said outlet end, said nozzle being mounted substantially axially within the outer fluid line and configured to direct said second fluid towards the outlet end of the outer fluid line, whereby said first and second fluids flowing through the inner and outer fluid lines are combined and flow together towards the outlet end of the outer fluid line.

2. A commingling device according to claim 1, wherein the outer fluid line is non-straight and the inner fluid line is substantially straight and includes an outlet end that is located substantially axially within a downstream portion of the outer fluid line.

3. A commingling device according to claim 2, wherein the outer fluid line is curved.

4. A commingling device according to claim 1, wherein the inner fluid line is non-straight and the outer fluid line includes a substantially straight pipe section, and the inner fluid line includes an outlet end that is located substantially axially within a downstream portion of the substantially straight pipe section.

5. A commingling device according to claim 4, including a Tee-piece pipe section comprising a substantially straight pipe section and a branch pipe section that intersects the substantially straight pipe section.

6. A commingling device according to claim 5, wherein the inner fluid line includes an inlet end mounted within the branch pipe section and an outlet end located within the substantially straight pipe section.

7. A commingling device according to claim 6, wherein the inner fluid line is curved.

8. A commingling device according to claim 6, wherein the inner fluid line includes an upstream portion that extends substantially perpendicular to a longitudinal axis of the substantially straight pipe section, and a downstream portion that extends substantially parallel to the longitudinal axis of the substantially straight pipe section.

9. A commingling device according to claim 1, including a Tee-piece pipe section comprising a substantially straight pipe section and a branch pipe section that intersects the substantially straight pipe section, and a removable inlet transfer pipe mounted within the Tee-piece pipe section and connected to the inlet end of either the substantially straight pipe section or the branch pipe section for guiding the flow of either the first fluid or the second fluid.

10. A commingling device according to claim 9, wherein the inlet transfer pipe is connected to the inlet end of the branch pipe section and comprises an upstream portion that extends substantially perpendicular to a longitudinal axis of the substantially straight pipe section, and a downstream portion that extends substantially parallel to the longitudinal axis of the substantially straight pipe section.

11. A commingling device according to claim 10, wherein the inlet transfer pipe is configured to be withdrawn from the substantially straight pipe section in a direction substantially perpendicular to a longitudinal axis of the substantially straight pipe section.

12. A commingling device according to claim 9, wherein the inlet transfer pipe mounted within the Tee-piece pipe section is connected to the inlet end of the substantially straight pipe section and extends towards the outlet end of the substantially straight pipe section.

13. A commingling device according to claim 12, including an outlet transfer pipe mounted within the Tee-piece pipe section, wherein said outlet transfer pipe is connected to the outlet end of the substantially straight pipe section and extends upstream towards the downstream end of the inlet transfer pipe.

14. A commingling device according to claim 1, further comprising a spinner device mounted within the inner fluid line and configured to cause rotation of said second fluid flowing within the inner fluid line.

15. A commingling device according to claim 1, further comprising a spinner device mounted within the outer fluid line and configured to cause rotation of said first fluid flowing within the outer fluid line.

16. A commingling device for combining fluid flows, comprising a first fluid line for a first fluid comprising an inlet end and an outlet end, and a second fluid line for a second fluid comprising an inlet end and an outlet end, wherein said second fluid line intersects said first fluid line between the inlet and outlet ends thereof, and wherein said second fluid line comprises a longitudinal axis that extends at an acute angle to a longitudinal axis of the first fluid line, whereby said first and second fluids flowing through the first and second fluid lines are combined and flow together towards the outlet end of the first fluid line.

17. A commingling device according to claim 16, wherein the longitudinal axis of said second fluid line extends at least partially tangentially with respect to the first fluid line, whereby said second fluids flowing into said first fluid lines are caused to rotate about a longitudinal axis of the first fluid line.

18. A commingling device for combining fluid flows, comprising a first fluid line for a first fluid having an inlet end and an outlet end, and a second fluid line for a second fluid having an inlet end and an outlet end, wherein said outlet end of said second fluid line is connected to said first fluid line through an intermediate pipe section having a plurality of apertures through which the second fluid can flow into the first fluid line.

19. A commingling device according to claim 18, wherein at least one of said apertures extends at an acute angle to a longitudinal axis of the first fluid line, whereby said first and second fluids flowing through the first and second fluid lines are combined and flow together towards the outlet end of the first fluid line.

20. A commingling device according to claim 18, wherein at least one of said apertures extends at least partially tangentially with respect to the first fluid line, whereby said second fluids flowing into said first fluid lines are caused to rotate about a longitudinal axis of the first fluid line.

21. A commingling device according to claim 16, wherein said first fluid line is piggable and has no substantial obstructions between the inlet and outlet ends thereof
